(19) United States
(12) Patent Application Publication
(10) Pub. No.: US 2009/0251459 A1
(43) Pub. Date: Oct. 8, 2009

(54) Method to Create, Edit and Display Virtual Dynamic Interactive Ambients and Environments in Three Dimensions

(75) Inventor: Norberto Navarro Valiente, Valencia (ES)

Correspondence Address: RICHARD M. GOLDBERG, 25 EAST SALEM STREET, SUITE 419, HACKENSACK, NJ, 07601, US

(73) Assignee: VIRTUAL EXPO DYNAMICS S.L., Valencia (ES)

(21) Appl. No.: 12/061,295

(22) Filed: Apr. 2, 2008

(51) Int. Cl. G06T 15/00

(52) U.S. Cl. 345/419; 345/581

(57) ABSTRACT

A method for creating, designing, editing and displaying virtual ambients and environments in three dimensions, that can be displayed at a computer display, and navigated by users connected with servers through a network with ten freedom ranges of movement along with sound effects with dynamic properties, including the steps of forming a three dimensional ambient or environment by prebuilt spaces and elements with predefined forms and editable properties, storing prebuilt spaces, elements and properties at databases at servers, permitting assigning, creating, editing and modifying of properties of the elements of the three dimensional ambient or environment by uploading to the database space coordinates in an xyz system, image files, descriptive texts, sound files, external or internal URL locations and data files, and determining a position of users inside the three dimensional ambient with reference to a predefined origin, by a computer program.

### BACKGROUND OF THE INVENTION

The present invention relates to a method for the creation, design, edition and display of virtual ambients and environments in three dimensions (vectorial three dimensional coordinates), that can be displayed at a computer display, navigated by users with ten freedom ranges of movement plus sound effects and with innovative dynamic properties.

The method can include a predetermined standard criteria for displaying the environment. The 10 freedom ranges are described below.

A three dimensional ambient or environment is composed of prebuilt spaces and prebuilt elements with predefined geometric properties. Spaces and elements have editable properties, such as:

1) predefined shape, that is, one element must be chosen from a list of elements, each of them having a predetermined shape, dimensions and structure;

2) color, that is, a color may be assigned to the surface of an element;

3) images, that is, images may be placed at the total or partial surface of an element;

4) textures, that is, visual textures may be assigned to the surface of an element;

5) sounds, that is, a sound file may be assigned to an element;

6) description texts to be assigned to an element, which shall be viewed when the mouse is hovering over the element;

7) keywords to be inserted by the user or administrator in connection with an element which allows the future ordination or selection of spaces;

8) related documents;

9) related URL; and

10) other properties.

All spaces and element properties are stored at one or multiple databases at one or multiple servers.

A three dimensional ambient or environment is built by loading from the databases the spaces and elements and the different properties of each element, whenever they have been previously defined by exhibitors and/or administrators.

The position of each of the users inside the three-dimensional ambient is referred to a predefined origin (start point) and is determined by a computer program calculating the movements of the user by using a navigation interface or device.

The properties of the elements of the three dimensional ambient or environment can be assigned, created, edited and modified by uploading the space coordinates (x,y,z), image files, descriptive texts, sound files, external or internal URL locations and data files to the databases using a browser.

All the parameters are recorded in a single server or multiple servers and are processed by means of a computer program that creates the necessary data to display at a computer screen and speakers the three-dimensional environment managing the spaces, elements and sounds following the properties assigned.

As a result of this method, the three-dimensional environment has the following properties managed by a computer program:

a) The three dimensional ambient or environment can be displayed in a dynamic way, changing the three-dimensional organization of its spaces and elements as a user requests keywords or phrases, and navigable by users with ten freedom ranges of movement plus sound effects.

b) The spaces and elements of the three dimensional ambient or environment can be listed as a flat document organized by keywords or phrases, and these listings can be read and indexed by Internet search engines.

c) The three dimensional ambient or environment can be displayed in virtual three dimensions as a three dimensional (3D) Directory with elements and spaces assigned to pre-defined categories and subcategories of information, each one placed on a three-dimensional ambient, navigable by users with ten freedom ranges of movement plus sound effects, using any kind of navigation virtual or physical apparatus.

d) The three dimensional ambient or environment can be published as an Internet web site connected to a network of any kind.

e) Visitors of the three dimensional ambient or environment can interact at any moment with other connected users or exhibitors (talk, chat, shop, negotiate, exchange files) if desired, or connect to a network of any kind.

f) Visitors of the three dimensional ambient or environment can access and interact with spaces and elements properties stored at databases with ten freedom ranges of movement plus sound effects.

g) It is also possible to have the user represented as any kind of avatar, as it is known from other three-dimensional ambients or environments and to track users or their interactions by any kind of tracking software.

Three dimension ambients and environments, displayed at a computer display, have existed since 1999, at systems as www.secondlife.com or www.kaneva.com, and also are used for display games of any kind.

### SUMMARY OF THE INVENTION

The method according to the present invention, unlike the known systems, creates these three dimension ambients and environments with prebuilt spaces and elements, with properties associated with a single database or multiple databases, and displays them in three dimensions in a dynamic way as requested by visitors using keywords or phrases.

Further, unlike the known systems, the method of the present invention, provides for editing the properties of each of the three dimension spaces and elements, and uploading to the server just image files, single data files and descriptive texts.

Up until now, to modify a three dimension ambient, it was necessary to upload new geometric models or program scripts. With the present invention, spaces and elements are prebuilt and stored at the server. Users select the space they want to own, choose the prebuilt elements for this space and assign the properties to these space and elements by uploading simple files and descriptive texts of these space and elements. No previous knowledge of scripting, programming or three dimension geometric building programs are needed.

Further, according to the present invention, spaces and elements in three dimension ambients or environments can be read and indexed by Internet search engines. This is possible because all elements and spaces are related to descriptive texts of its properties and all this information is stored at databases.

Still further, according to the present invention, three dimension ambients or environments can be displayed as a three Dimension Directory, organized by predefined categories and subcategories.

Three-dimensional ambients and environments, displayed in a computer display and navigable by visitors connected to a network of any kind, are the next step of accessibility to the information. The only problem is to provide a method to organize the information at these three-dimensional ambients or environments.

At any information centers, such as shopping centers, exhibition or convention centers with a lot of information of products, the only way to make a virtual three dimensional environment useful is to organize the elements of this environment related to the information displayed. Doing this, visitors of the three-dimensional virtual environment do not need spend a lot of time surfing all environments or searching a specific product because all three-dimensional environments can be organized following a visitor's own criteria.

In other words, the usability for the visitors is related so as to have the three-dimensional environment in a dynamic way where every visitor can organize the ambient specifically for the visitor's needs, and where every visitor can see the same ambient but displayed in a different manner than others, just by placing the keywords or phrases criteria about what he is searching or looking for inside the three dimensional (3D) environment.

For being actually useful, three dimensional environments need also serve the interest of the exhibitors and its products or information displayed at elements. If administrators and exhibitors need program scripts, or can only modify the three-dimensional model using a three dimensional (3D) design computer program, then any need to change the elements to change the information can not be resolved instantly. Many times, it is necessary to rent the services of other specialized companies to manage the environment.

With the method of the present invention, the prebuilt spaces and elements and information related to them can be created, edited and changed instantly by exhibitors and administrators, and displayed always updated to visitors.

Like this, actual changes of the state of any product or service will be shown to visitors as it is at every moment. Also, this can be canceled as available and new products and services are added by uploading simple files to the database.

Of course, the three-dimensional environment is not limited to these spaces and elements, since it can contain many other objects, such as exhibition centers, shopping centers, streets, places, avenues, museum or art exhibitions, villages or groups of villages, real estate projects or the like, whereas all objects can either be reproduced by the environment or are already built in.

It is also possible to have the environment connected to a shopping system, a search engine or a network of any kind, for example, a network in a hotel or convention center, in order to give information in a virtual three-dimensional ambient or environment to guests or visitors.

The above and other features of the invention will become readily apparent from the following detailed description thereof which is to be read in connection with the accompanying drawings.

### BRIEF DESCRIPTION OF THE DRAWINGS

FIG. 1 is a flow chart of the steps for a new exhibitor according to the present invention;

FIG. 2 is a flow chart of the steps for an exhibitor owner of an already built space according to the present invention;

FIG. 3 is a flow chart of the steps for a visitor according to the present invention; and

FIG. 4 is a flow chart of the steps for a search engine according to the present invention.

### DETAILED DESCRIPTION

In discussing the present invention, the following terms will be used, and a description thereof is provided below:

a) Three-dimensional ambient or environment: This is the virtual space generated by a computer software and displayed at computer screen interface.

Where objects have position defined by the length, depth and height related to an origin, these coordinates are referred to as X (length), Y (depth) and Z (height).

Where objects have a defined length, depth and height, this determines the volume.

Where objects have a geometric form defined with a grid composed by polygons, these polygons are called “faces” of the object.

Faces can have colors, images and textures assigned.

Visitors (also called observers) of the environment can see a different displayed view at the computer screen interface as a function of their own position coordinates of length, depth and height related to the origin of the environment.

Sounds reinforcing the reality of the environment can be played at computer speakers.

b) Spaces: These are surfaces and volumes defined at the environment.

c) Elements: These are objects placed at defined surfaces or volumes of the environment.

d) Ranges of Movement: This is a possible transition of the position coordinates of the observer, and there can be up to ten ranges of movement as follows:
1) Move forward,
2) Move backward,
3) Move right,
4) Move left,
5) Rotate right,
6) Rotate left,
7) Move up,
8) Move down,
9) Look up and
10) Look down.

e) Exhibitor: This is the owner of a space in the three-dimensional environment.

f) Visitor (also called User or Observer): This is the user navigating the three-dimensional virtual environment.

g) Navigating the virtual three-dimensional environment: This is modification of the images and sounds to be seen as a result of the transition from one position of the observer to other position. These sequences of images are displayed at the computer screen interface, giving the observer the sensation of moving as he moves in the real world. The sequence of sounds is played at the computer speakers or at any other computer sound interface. The transition from one position of the virtual three-dimensional environment to another position is commanded by the user, using keyboard keys, mouse movements or using a virtual or physical navigator apparatus.

h) Virtual navigator apparatus: This is a set of software commands contained at a computer screen and displayed as icons. By clicking or moving the icons, the position coordinates at the virtual three-dimensional environment change to other ones.

i) Physical navigator apparatus: This is known also as a joystick or similar interface.

k) Indexability: This is the ability of a search engine or any information organizer to read the descriptive information assigned to a space, object, element or sound of the three-dimensional virtual environment. This information is stored at one or multiple databases at one or multiple computers (also called servers).

The innovative method of the present invention is based on the construction of the three dimensional ambient or environment with prebuilt geometric spaces and prebuilt elements stored in a database.

The spaces and elements of the three-dimensional environment have properties (geometric form, descriptive texts, images, textures, sounds, etc.) that also are stored at one or multiple databases and can be created, edited and modified just by being connected to the server with a simple browser interface.

This means that the final three dimensional environment displayed at a computer screen to the visitors is generated with the database data of prebuilt spaces and elements according to stored properties, and can be displayed to everyone in a different manner following the criteria of its specific needs.

The method of the present invention gives the ability to link three-dimensional spaces and elements stored in a database with descriptive information texts in order to organize the three-dimensional ambient or environment with a keywords or phrases criteria.

The present method also gives the ability to link three-dimensional spaces and elements stored in a database with images, sounds and textures in order to modify how these spaces and elements are displayed to users.

The present method also gives the ability to create a three-dimensional directory with categories and subcategories of information defined by administrators and exhibitors and to link every element of the three-dimensional environment to these categories and subcategories.

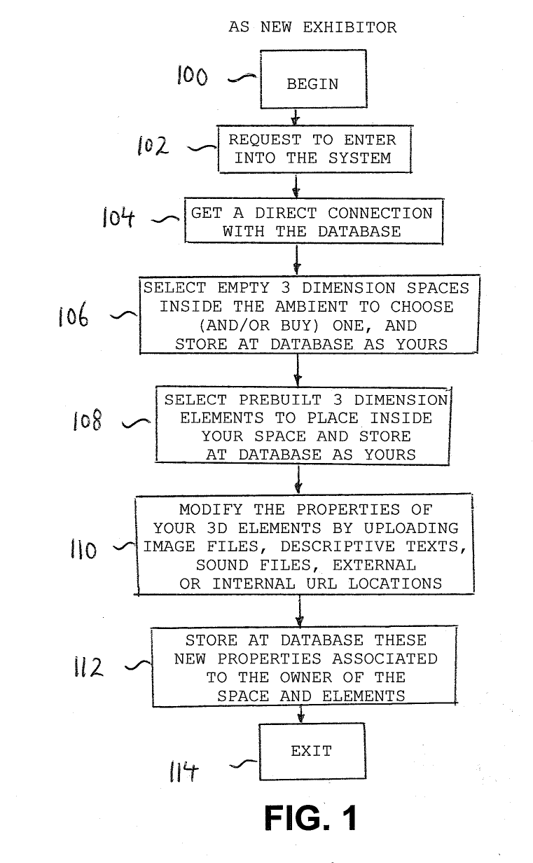

Referring now to FIGS. 1-4, flow charts illustrating the method according to the present invention will now be discussed.

FIG. 1 is a flow chart of the steps taken as a new exhibitor of the present method. In step 100, the process begins. In step 102, the user requests entry into the system, and in step 104, the user obtains direct connection with the database. In step 106, the user selects empty three dimension spaces inside the ambient to choose (and/or buy) one, and to store this at the database as his own. In step 108, the user then selects prebuilt three dimension elements to place inside his space, and to store this at the database as his own. In step 110, the user can modify the properties of his three dimensional elements by uploading image files, descriptive texts, sound files, external or internal URL locations. In step 112, these new properties associated to the owner of the space and elements are stored at the database. Then, in step 114, the process is ended and the user can exit.

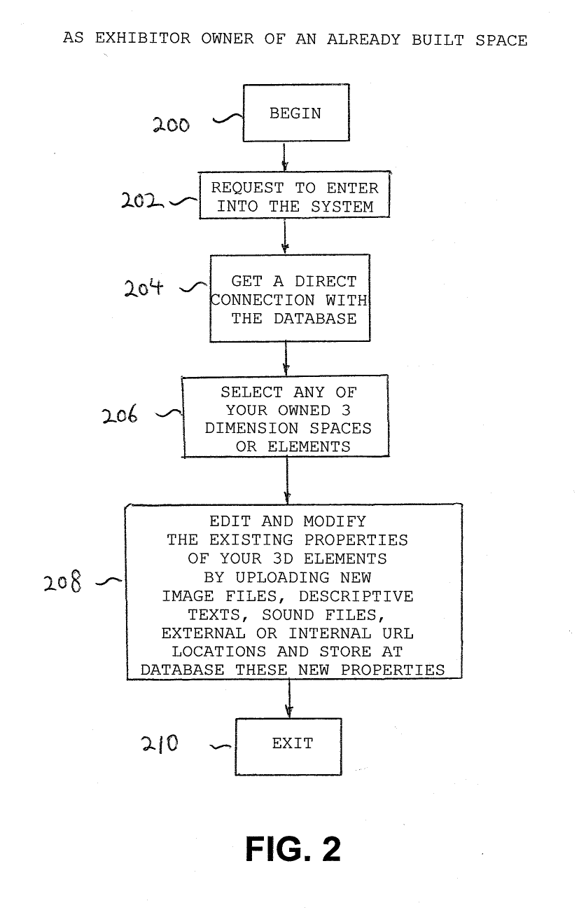

FIG. 2 is a flow chart of the steps taken as an exhibitor owner of an already built space. In step 200, the process begins. In step 202, the user requests entry into the system, and in step 204, the user obtains direct connection with the database. In step 206, the user selects any of his owned three dimension spaces or elements. In step 208, the user can edit and modify the existing properties of his three dimensional elements by uploading new image files, descriptive texts, sound files, external or internal URL locations and store these new properties at the database. Then, in step 210, the process is ended and the user can exit.

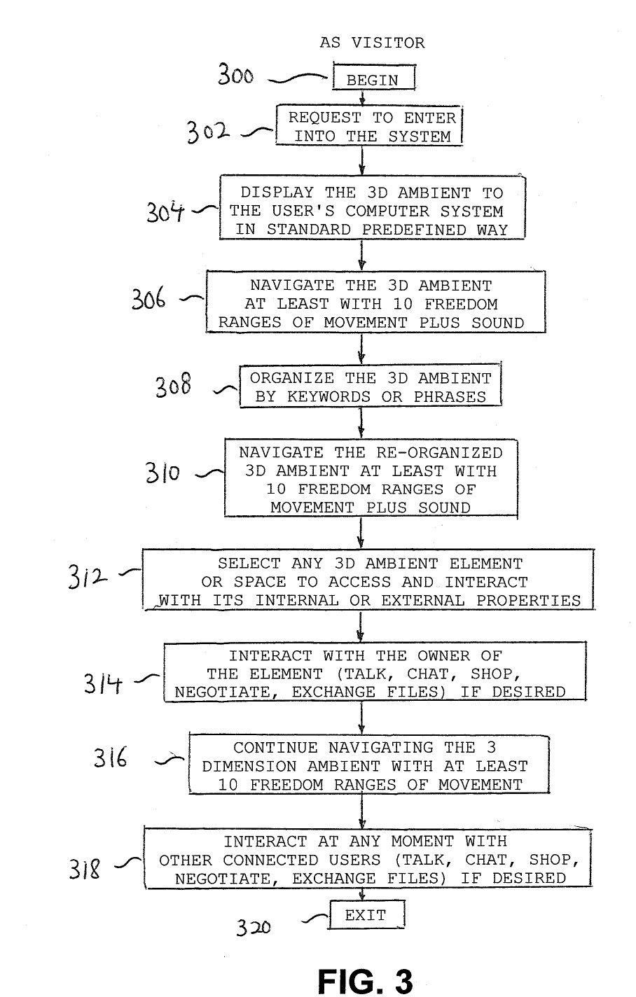

FIG. 3 is a flow chart of the steps taken as a visitor. In step 300, the process begins. In step 302, the user requests entry into the system. In step 304, the three dimensional ambient is displayed to the user's computer system in a standard predefined way. In step 306, the user navigates the three dimensional ambient at least with ten freedom ranges of movement plus sound. In step 308, the use can organize the three dimensional ambient by keywords or phrases. In step 310, the user can navigate the re-organized three dimensional ambient at least with ten freedom ranges of movement plus sound. In step 312, the user can select any three dimensional ambient element or space to access and interact with its internal or external properties. In step 314, the user can interact with the owner of the element (talk, chat, shop, negotiate, exchange files) if desired. In step 316, the user can continue navigating the three dimensional ambient with at least ten freedom ranges of movement. At any moment, in step 318, the user can interact with other connected users (talk, chat, shop, negotiate, exchange files) if desired. Then, in step 320, the process is ended and the user can exit.

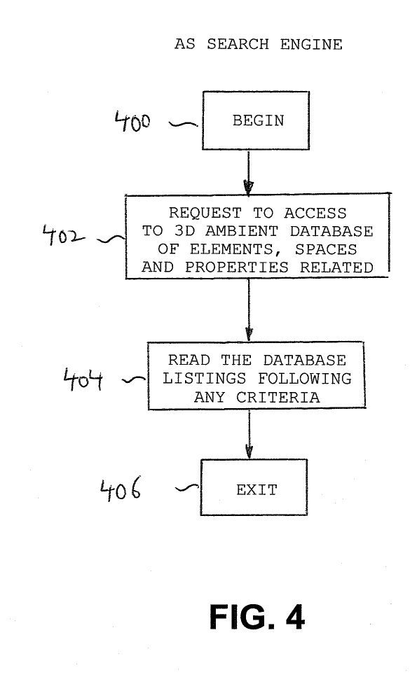

FIG. 4 is a flow chart of the steps taken as a search engine. In step 400, the process begins. In step 402, access is requested to the three dimensional ambient database of elements, spaces and related properties. In step 404, the database listings following any criteria, are read. In step 406, the process is terminated and exits the system.

A more detailed description of the method of the present invention will now be discussed.

The basis of the method of the present invention is to split the tri-dimensional ambient in different parts (entities as general areas, buildings, spaces, stands and elements) and assign to each one properties, possible positions, descriptive texts and keywords and storing individually each part in a database.

A software application manages the database tables containing several fields hosting all entities and the properties assigned to each one with the keywords and descriptive texts assigned that are used to re-organize the tri-dimensional environment following a visitor's request of keywords or phrases.

The outline of the method is as follows.

The present method splits the tri-dimensional environment in several parts (entities) stored at the database at different tables and folders.

General areas with a pre-defined geometry and its properties and descriptive texts and keywords are assigned. Buildings with a predefined geometry and its properties and descriptive texts and keywords are assigned. Spaces inside the buildings and inside the general areas and its properties and descriptive texts and keywords are assigned. Stands and individual elements stored with a pre-defined geometry and placed inside the buildings with its properties and descriptive texts and keywords are assigned.

Each kind of tri-dimensional entity is hosted in a different database table and folder that contain also fields to store the properties, descriptive texts and keywords assigned to each entity. The different folders are as follows:

Folder of General Areas: This database folder contains in different fields the geometric entities and its properties used to let users move between different buildings (entry, corridors, ground, background, avatars). It also contains the possible positions and properties of these general areas, such as color, textures, sounds, descriptive texts and documents associated to these areas information. It also contains references to the origin of coordinates as a start point where other entities of the three dimensional environment have a referred position.

Folder of Buildings: This database folder contains in different fields the name of a tri-dimensional group of each building, and the addresses of the files to be loaded with the predefined geometry. It also contains the possible position coordinates and properties of these buildings, such as colors, textures, sounds, descriptive texts and documents associated. The buildings are used to contain the stands and elements.

Folder of Spaces: This database folder contains the possible position coordinates and the dimensions of each available space inside the buildings and general areas and also the owners of each pre-defined space of the tri-dimensional environment.

Folder of Stands: This database folder contains the geometric blank models of the stands and its elements and also of the individual elements (displays) inside the buildings, the name of the geometric groups and models of each one, the properties assigned to each stand and its elements by its owner, such as colors, textures, sounds, descriptive texts, keywords, documents associated and the possible coordinates where to place the stand and elements inside a building or a general space. It also contains where to find (network address) the files associated to each property if there are external files or documents placed in a network of any kind.

The final tri-dimensional ambient or environment is built and edited, as follows.

The administrator of the tri-dimensional environment inputs at the database the geometric data and properties of the general areas, the buildings and the available spaces at the tri-dimensional environment. The administrator also inputs at the database folders the available blank stand's models and individual elements that can be owned by one exhibitor, and also the possible properties and positions for each of them. The administrator also inputs at the database the predefined way to display the tri-dimensional environment or ambient.

Using simple interface and intuitive instructions from the application software, the exhibitors of the tri-dimensional environment choose an available empty space. Also, they choose a blank stand or individual element between the different geometric models available at the database. When the stand or individual element is selected, the exhibitor assigns the properties to the predefined elements, writing also the descriptive texts and keywords in an intuitive browser interface. The exhibitor can edit these properties at any time using the same application interface.

The properties, such as color, texture, sounds and associated keywords and descriptive texts and documents of each element, are just uploaded to the database folders. All properties, descriptive texts and keywords data are stored at database fields as described previously.

The final tri-dimensional ambient or environment is displayed as follows:

1. The first step is to load the software application that manages all database data.

2. Then, the application displays to the visitor the tri-dimensional ambient in a predefined way organization and all the functions the user needs to move inside the tri-dimensional ambient and to interact with other users and exhibitors. This predefined way is managed and defined by the administrator of the tri-dimensional ambient or environment.

3. The application also displays to the visitor the necessary windows and menus to let him choose the keywords or phrases to rebuild the tri-dimensional ambient following its needs.

4. The visitor of the tri-dimensional environment inputs the keywords or phrases to request a new organization of the tri-dimensional ambient following its needs.

5. The software application makes a database call to know which general spaces, buildings, stands and elements satisfy the visitor's request and organizes the tri-dimensional environment following the visitor's criteria.

6. The software application displays to the visitor the tri-dimensional environment with the general spaces, buildings and elements organized following the request of keywords or phrases. At same time, the application displays again the menus and windows to rebuild the ambient if the visitor needs another new organization and all the functions the user needs to move inside the tri-dimensional ambient and to interact with other users and exhibitors.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention as defined by the appended claims.

What is claimed is:

1. A method for creating, designing, editing and displaying virtual ambients and environments in three dimensions, that can be displayed at a computer display, and navigated by users connected with servers through a network, with ten freedom ranges of movement including any of moving forward, moving backward, moving right, moving left, rotating right, rotating left, moving up, moving down, optionally looking up, and optionally looking down, along with sound effects with dynamic properties, said method comprising the steps of:
forming a three dimensional ambient or environment by prebuilt spaces and elements with predefined forms and editable properties,
storing prebuilt spaces, elements and properties at least one database at least one server and managed by a computer program,
permitting assigning, creating, editing and modifying of properties of the elements of the three dimensional ambient or environment by uploading to the at least one database space coordinates in an xyz system, image files, descriptive texts, sound files, external or internal URL locations and data files using a browser,
determining a position of users inside the three dimensional ambient with reference to a predefined origin, by a computer program calculating movements of the users that are using any navigation interface or device,
installing a system for performing the method on at least one computer server as a computer program that creates necessary data to display at a computer screen and to create sound through a computer sound interface, and
managing the spaces, elements, and sounds following the properties assigned, by the three-dimensional environment.

2. The method of claim 1, further comprising the step of displaying a changing three-dimensional organization of the three dimensional ambient or environment on a computer screen in a dynamic way according to a user's request of keywords or phrases.

3. The method of claim 1, further comprising the step of listing the spaces and elements of the three dimensional ambient or environment as flat text documents organized by keywords or phrases which can be read and indexed by Internet search engines.

4. The method of claim 1, further comprising the step of displaying the three dimensional ambient or environment on a computer screen as a three dimensional directory with elements and spaces assigned to predefined categories and subcategories of information, each one placed on a three-dimensional ambient navigable by users with ten freedom ranges of movement plus sound effects.

5. The method of claim 1, further comprising the step of publishing and displaying the three dimensional ambient or environment as an Internet web site connected to a network of any kind.

6. The method of claim 1, further comprising the step of permitting visitors of the three dimensional ambient or environment to interact at any moment with other connected users by any one of the following: talking, chatting, shopping, negotiating and exchanging files, by being connected to a network.

7. The method of claim 1, further comprising the step of permitting visitors of the three dimensional ambient or environment to access and interact with spaces and elements properties stored at databases with up to ten freedom ranges of movement plus sound effects.

8. The method of claim 1, wherein the three-dimensional environment reproduces an exhibition center.

9. The method of claim 1, wherein the three-dimensional environment reproduces a shopping center.

10. The method of claim 1, wherein the three-dimensional environment reproduces streets, places or avenues.

11. The method of claim 1, wherein the three-dimensional environment reproduces a museum or art exhibition.

12. The method of claim 1, wherein the three-dimensional environment reproduces a village or group of villages.

13. The method of claim 1, wherein the three-dimensional environment reproduces a real estate project or already built real estate property.

14. The method of claim 1, wherein the system for performing the method is connected to a shopping system.

15. The method of claim 1, wherein the system for performing the method is connected to a search engine.

16. The method of claim 1, wherein the system for performing the method is connected to a network in a hotel or convention center in order to give information in a virtual three-dimensional ambient or environment to guests or visitors.

17. The method of claim 1, further comprising the step of providing interaction between exhibitors and visitors.

18. The method of claim 1, further comprising the step of displaying the environment via a predetermined standard criteria.

19. The method of claim 1, further comprising the step of permitting users to change their position coordinates in the three-dimensional ambient using virtual navigation or physical apparatus.

20. The method of claim 1, further comprising the step of representing users as an avatar.

21. The method of claim 1, further comprising the step of tracking user interactions by tracking software.

22. The method of claim 1, further comprising the steps of:
dynamically displaying the three dimensional ambient or environment, and
changing organization of the spaces and elements at a user's request of keywords or phrases, referring to properties of the spaces or elements.
